(19) United States
(12) Patent Application Publication
(10) Pub. No.: US 2026/0177055 A1
(43) Pub. Date: Jun. 25, 2026

(54) INTERNAL GEAR PUMP

(71) Applicant: Sumitomo Electric Sintered Alloy, Ltd., Takahashi-shi, Okayama (JP)

(72) Inventor: Shoichi TAKADA, Takahashi-shi, Okayama (JP)

(73) Assignee: Sumitomo Electric Sintered Alloy, Ltd., Takahashi-shi, Okayama (JP)

(21) Appl. No.: 18/834,635

(22) PCT Filed: Sep. 14, 2023
(86) PCT No.: PCT/JP2023/033627

§ 371 Date: Jul. 31, 2024

(30) Foreign Application Priority Data
Dec. 19, 2022 (JP) 2022-202209

(51) Int. Cl. F04C 2/10

(52) U.S. Cl. CPC F04C 2/10; F04C 2240/30

(57) ABSTRACT

An internal gear pump comprises an inner rotor including a plurality of external teeth, an outer rotor including a plurality of internal teeth engaging with the plurality of external teeth, a housing rotatably housing the inner rotor and the outer rotor, and an axial gap motor including a stator and a motor rotor. The outer rotor is the motor rotor. The housing includes a peripheral wall portion provided in a cylindrical form so as to surround an outer periphery of the outer rotor, and a first cover portion and a second cover portion each covering a corresponding one of two end portions of the peripheral wall portion. The first cover portion is disposed between the stator and the outer rotor. The second cover portion has a suction port and a discharge port that communicate with an inside of the housing.

### TECHNICAL FIELD

The present disclosure relates to an internal gear pump. This application claims priority based on Japanese Patent Application No. 2022-202209 filed on Dec. 19, 2022, and the entire contents of the Japanese patent application are incorporated herein by reference.

### BACKGROUND ART

Patent literature 1 discloses an electric pump including an axial gap type rotor. The axial gap type rotor is an impeller integrated rotor including an impeller and a magnet supported by the impeller. The impeller and the magnet are arranged side by side along a rotary shaft of the impeller. That is, the impeller to which the rotational force of the rotor is transmitted and the rotor are arranged in parallel along the rotary shaft of the rotor.

### CITATION LIST

### Patent Literature

[Patent literature 1] Japanese Unexamined Patent Application Publication No. 2020-182269

### SUMMARY OF INVENTION

An internal gear pump of the present disclosure includes an inner rotor including a plurality of external teeth, an outer rotor including a plurality of internal teeth engaging with the plurality of external teeth, a housing rotatably housing the inner rotor and the outer rotor, and an axial gap motor including a stator and a motor rotor. The outer rotor is the motor rotor. The housing includes a peripheral wall portion provided in a cylindrical form so as to surround an outer periphery of the outer rotor, and a first cover portion and a second cover portion each covering a corresponding one of two end portions of the peripheral wall portion. The first cover portion is disposed between the stator and the outer rotor. The second cover portion has a suction port and a discharge port that communicate with an inside of the housing.

### BRIEF DESCRIPTION OF THE DRAWINGS

FIG. 1 is a schematic cross-sectional view of an internal gear pump according to an embodiment.

FIG. 2 is an explanatory view of a stator provided in an internal gear pump according to an embodiment.

FIG. 3 is an explanatory view of an inner rotor and an outer rotor provided in an internal gear pump according to an embodiment.

### DETAILED DESCRIPTION

### Problems to be Solved by Present Disclosure

When the impeller and the rotor are arranged side by side along the rotary shaft of the rotor, the entire rotor tends to be increased in size even in the rotor in which the impeller is integrated. There is a demand for electric pumps that can be miniaturized.

One of objects of the present disclosure is to provide an internal gear pump that can be miniaturized.

### Advantageous Effects of Present Disclosure

The internal gear pump of the present disclosure can be miniaturized.

### Description of Embodiments of Present Disclosure

First, embodiments of the present disclosure will be listed and described.

(1) An internal gear pump according to an embodiment of the present disclosure includes an inner rotor including a plurality of external teeth, an outer rotor including a plurality of internal teeth engaging with the plurality of external teeth, a housing rotatably housing the inner rotor and the outer rotor, and an axial gap motor including a stator and a motor rotor. The outer rotor is the motor rotor. The housing includes a peripheral wall portion provided in a cylindrical form so as to surround an outer periphery of the outer rotor, and a first cover portion and a second cover portion each covering a corresponding one of two end portions of the peripheral wall portion. The first cover portion is disposed between the stator and the outer rotor. The second cover portion has a suction port and a discharge port that communicate with an inside of the housing.

In the internal gear pump, the outer rotor functions as the motor rotor, and thus the internal gear pump can be miniaturized. In the internal gear pump, the outer rotor is a driving source, and the inner rotor is passive as the outer rotor is driven. The internal gear pump satisfies a first configuration and a second configuration. The first configuration is that one or more components to which the rotational force of the motor rotor is transmitted are disposed in an internal space of the annular motor rotor as a drive source.

In the internal gear pump satisfying the first configuration, the size of the motor rotor in the direction along the rotary shaft can be easily reduced as compared with the case where the motor rotor and the outer rotor are formed of independent members. The second configuration is that the motor rotor and the stator are disposed to face each other with the first cover portion interposed therebetween. In the internal gear pump satisfying the second configuration, the size of the motor rotor in the direction along the diameter can be easily reduced as compared with the case where the motor rotor and the outer rotor are formed of independent members and the inner rotor and the outer rotor are disposed in the inner space of the annular stator.

In the internal gear pump, the outer rotor is surrounded by the peripheral wall portion, and the first cover portion is disposed between the motor rotor and the stator, so that the sealing performance of the housing is enhanced. Therefore, the internal gear pump appropriately functions as an electric pump.

In the internal gear pump, the operation noise from the inner rotor and the outer rotor is hardly propagated to the outside of the housing due to the first configuration. Therefore, the internal gear pump is excellent in quietness. The operation noise is, for example, teeth striking noise between the external tooth of the inner rotor and the internal tooth of the outer rotor or a vibration noise.

In the internal gear pump, the first configuration makes it easy for the heat generated in the motor rotor, that is, the heat generated in the outer rotor, to be transferred to the fluid, and makes it easy for the temperature of the fluid to rise. As the temperature of the fluid increases, the viscosity of the fluid decreases. As a result, the load of the axial gap motor is reduced, and the power consumption of the axial gap motor is reduced. The heat generated in the motor rotor is transmitted to the fluid, and thus the heat generation of the motor rotor can be suppressed.

(2) In the internal gear pump according to the (1), the first cover portion may be made of a nonmagnetic material.

When the first cover portion is made of a nonmagnetic material, the influence on the magnetic flux from the stator to the motor rotor, that is, from the stator to the outer rotor is smaller than that in the case where the first cover portion is made of a magnetic material. When the first cover portion is made of a nonmagnetic material, the outer rotor can rotate appropriately with rotating magnetic field of the stator.

(3) In the internal gear pump according to the (1) or (2), a thickness of the first cover portion may be 0.3 mm to 5 mm.

When the thickness of the first cover portion is 0.3 mm or more, the strength of the first cover portion can be enhanced, and the first cover portion is hardly deformed even when the outer rotor slides on the first cover portion. When the first cover portion is hardly deformed, the sealing performance of the housing is easily enhanced. When the thickness of the first cover portion is 0.3 mm or more, the operation noise generated by the inner rotor and the outer rotor is hardly propagated to the outside of the housing. When the thickness of the first cover portion is 5 mm or less, the motor rotor can rotate easily with the rotating magnetic field of the stator.

(4) In the internal gear pump according to any one of the (1) to (3), a clearance between the first cover portion and the outer rotor may be 0.01 mm to 0.20 mm.

When the clearance is 0.01 mm or more, the first cover portion and the outer rotor are hardly slide on each other, and the occurrence of wear or seizure between the first cover portion and the outer rotor can be suppressed. When the clearance is 0.20 mm or less, the fluid is hardly leak to the outer periphery of the outer rotor through the clearance, and the function of the internal gear pump is favorably exhibited.

### Details of Embodiments of Present Disclosure

An example of the internal gear pump of the present disclosure will be described with reference to the drawings. In the drawings, the same reference numerals denote the same or corresponding parts. In the drawings, some components may be exaggerated or simplified for convenience of description. The dimensional ratio of each part in the drawings may be different from the actual one. The present invention is not limited to these examples, but is defined by the scope of the claims, and is intended to include all modifications within the meaning and scope equivalent to the scope of the claims.

### <Outline>

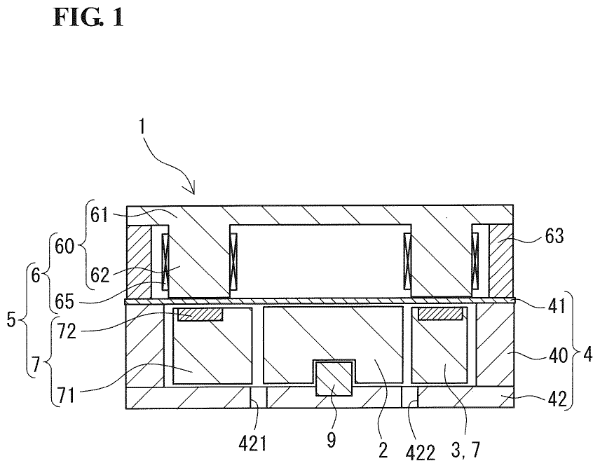

As shown in FIG. 1, an internal gear pump 1 of the embodiment includes an inner rotor 2, an outer rotor 3, a housing 4, and an axial gap motor 5. One of the features of internal gear pump 1 of the embodiment is that outer rotor 3 is a motor rotor 7 of axial gap motor 5. Another feature of internal gear pump 1 of the embodiment is that a first cover portion 41 of housing 4 is disposed between motor rotor 7 and a stator 6 of axial gap motor 5.

### <Axial Gap Motor>

Axial gap motor 5 includes stator 6 and motor rotor 7. Stator 6 and motor rotor 7 are disposed coaxially with the rotary shaft of motor rotor 7. Stator 6 and motor rotor 7 face each other with a gap therebetween in a direction along the rotary shaft. Axial gap motor 5 is a single stator/single rotor type motor including one stator 6 and one motor rotor 7.

### <Stator>

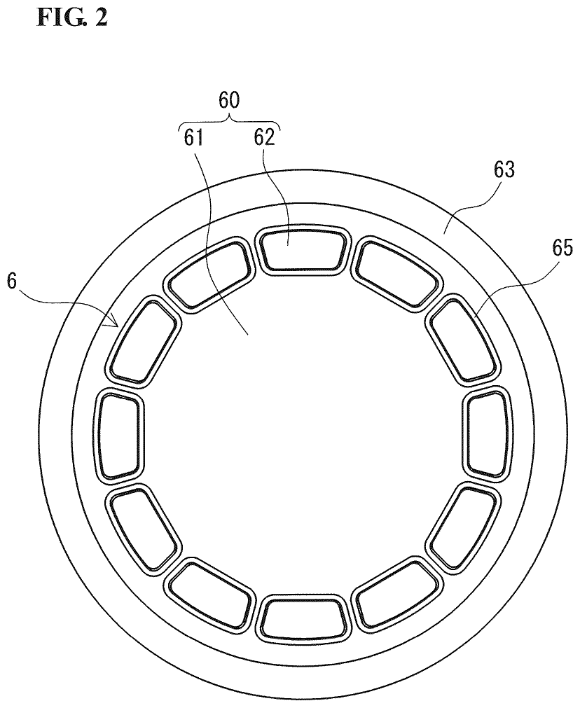

As shown in FIGS. 1 and 2, stator 6 includes a stator core 60 and a plurality of coils 65.

Stator core 60 includes a yoke 61 and a plurality of teeth 62. Yoke 61 is, for example, a circular plate. Yoke 61 may be an annular plate. Each tooth 62 is a columnar body. Each tooth 62 protrudes from either the front or back surface of yoke 61. Each tooth 62 is arranged at intervals along the entire circumference of yoke 61. Each tooth 62 is arranged at equal intervals, for example. Each tooth 62 has the same shape and the same size. Each tooth 62 has a prismatic shape or a cylindrical shape, for example. Yoke 61 and teeth 62 are formed integrally from, for example, a powder molded body. Yoke 61 and teeth 62 may be independent members and may be bonded to each other. Yoke 61 magnetically couples adjacent teeth 62 among the plurality of teeth 62.

A distal end surface of each tooth 62 faces motor rotor 7 described later. Each tooth 62 is provided with coil 65. In FIGS. 1 and 2, an end of a winding constituting coil 65 is not shown.

Stator core 60 of the present embodiment includes annular peripheral wall portion 63 disposed on a peripheral edge portion of yoke 61. Peripheral wall portion 63 is provided on a surface of yoke 61 from which each tooth 62 protrudes. The height of peripheral wall portion 63 is equal to or greater than the height of each of teeth 62. A distal end surface of peripheral wall portion 63 is connected to first cover portion 41 of housing 4, which will be described later. Peripheral wall portion 63 may be formed of a powder molded body integrated with yoke 61, or may be formed of a member independent of yoke 61. Peripheral wall portion 63, which is a member independent of yoke 61, is fixed to yoke 61 by, for example, an adhesive or a screw.

### <Motor Rotor>

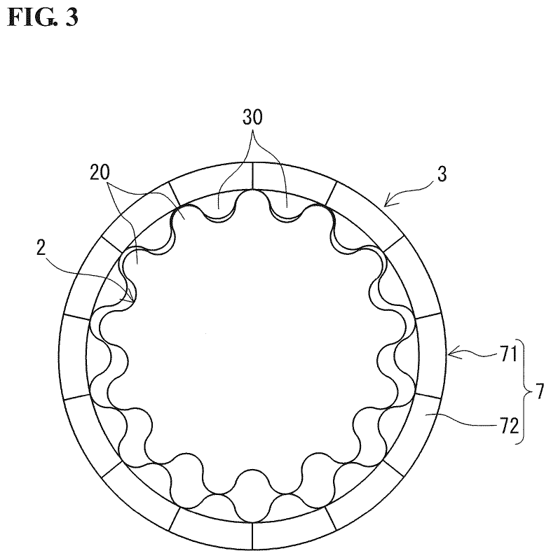

As shown in FIGS. 1 and 3, motor rotor 7 includes a base portion 71 and a magnet 72.

As shown in FIG. 3, base portion 71 is a tubular body having a through hole. Base portion 71 includes a plurality of internal teeth 30 provided on an inner periphery surface of base portion 71. Inner rotor 2, which will be described later, is disposed in the through hole of base portion 71. Internal tooth 30 has a shape and a size corresponding to an external tooth 20 of inner rotor 2. Base portion 71 rotates while an outer periphery surface of base portion 71 is pressed by a peripheral wall portion 40 of housing 4 to be described below. A clearance is provided between the outer periphery surface of base portion 71 and an inner periphery surface of peripheral wall portion 40. A liquid film may be present in the clearance. In this case, base portion 71 rotates in a fluid lubricating state while being supported by the reaction force of the film. When the film is not present in the clearance, base portion 71 rotates in a boundary lubrication state.

Base portion 71 includes a first surface, a second surface, an inner periphery surface, and an outer periphery surface. The first surface is a surface facing first cover portion 41 of housing 4 described later. The second surface is a surface facing a second cover portion 42 of housing 4 described later. The inner periphery surface is a surface facing inner rotor 2 described later. The outer periphery surface is a surface facing peripheral wall portion 40 of housing 4 described later. Each of the inner periphery surface and the outer periphery surface connects the first surface and the second surface. Base portion 71 is made of, for example, an iron-based material.

Magnet 72 is disposed in the first surface of base portion 71. In other words, magnet 72 is disposed in a surface of base portion 71 facing first cover portion 41. In the relationship between stator 6 and motor rotor 7, magnet 72 faces the distal end surfaces of teeth 62.

Magnet 72 is fixed to base portion 71. The first surface of base portion 71 and a surface of magnet 72 are flush with each other. Magnet 72 is fixed to base portion 71 by, for example, an adhesive. For example, a recess may be provided on the first surface of base portion 71, and magnet 72 may be bonded to the inside of the recess by an adhesive. Magnet 72 is disposed in the recess, and thus the first surface of base portion 71 and the surface of magnet 72 can be flush with each other. Magnet 72 may be fixed so as to be embedded in the constituent material of base portion 71. Base portion 71 may be formed of a resin molded body. In this case, magnet 72 may be insert-molded with resin so that the surface of magnet 72 is exposed. The resin may be a thermoplastic resin or a thermosetting resin.

The number of magnets 72 may be one or more. When the number of magnets 72 is one, the shape of magnet 72 is annular. In annular magnet 72, S poles and N poles are alternately arranged clockwise or counterclockwise. When magnet 72 is provided in plurality, the plurality of magnets 72 are arranged along the entire circumference of base portion 71. When the number of internal teeth 30 of outer rotor 3 is an even number, the number of magnets 72 may be the same as the number of internal teeth 30, or may be a multiple of the number of internal teeth 30. The number of magnets 72 may be different from the number of internal teeth 30. The shape of each magnet 72 is, for example, a flat plate shape. The planar shape of each magnet 72 is the same as the planar shape of the distal end surface of each tooth 62, for example. Magnet 72 is a permanent magnet.

Each magnet 72 is magnetized in a direction along the rotary shaft of motor rotor 7. The magnetization directions of magnets 72 adjacent to each other along the entire circumference of base portion 71 are opposite to each other. Motor rotor 7 rotates with respect to stator 6 by magnet 72 repeatedly attracting and repelling each tooth 62 by a rotating magnetic field generated by coil 65 which is excited by passing a current through coil 65 in stator 6.

### <Inner Rotor>

As shown in FIGS. 1 and 3, inner rotor 2 is disposed in an internal space of motor rotor 7. The internal space of motor rotor 7 is a space configured by a through hole in base portion 71 having the through hole. Inner rotor 2 is a tubular shaped body or a block body having the plurality of external teeth 20. Each external tooth 20 has a tooth shape formed by a trochoid curve, for example. In the present embodiment, the number of external teeth 20 is one less than the number of internal teeth 30.

Inner rotor 2 is rotatably supported with respect to a pin 9. Pin 9 is disposed at the center of inner rotor 2. Pin 9 is fixed to second cover portion 42 of housing 4 described later. Inner rotor 2 and pin 9 may be integrated with each other, and pin 9 may be rotatably supported with respect to second cover portion 42. Inner rotor 2 may be rotatably supported with respect to a shaft (not shown) instead of pin 9.

Inner rotor 2 is eccentric with respect to the center of outer rotor 3. That is, inner rotor 2 is also eccentric with respect to the center of the plurality of teeth 62 arranged in an annular shape.

### <Outer Rotor>

Outer rotor 3 is above-described motor rotor 7. Outer rotor 3 includes the plurality of internal teeth 30 that engage with the plurality of external teeth 20. The number of internal teeth 30 is one more than the number of external teeth 20. A substantially sealed space is formed by the tooth tips of external tooth 20 and internal tooth 30. The number of internal teeth 30 may be an even number or an odd number.

Outer rotor 3 is a driving source. Since outer rotor 3 is motor rotor 7, motor rotor 7 rotates with respect to stator 6, that is, outer rotor 3 rotates with respect to stator 6. When outer rotor 3 rotates, internal tooth 30 and external tooth 20 are engaged with each other, and thus inner rotor 2 rotates in the same direction by following outer rotor 3. In a general internal gear pump, a shaft is provided in an inner rotor, and when the inner rotor rotates, an outer rotor rotates in the same direction by following the rotation of the inner rotor. That is, the driving side rotor and the driven side rotor in internal gear pump 1 of the present embodiment are opposite to the driving side rotor and the driven side rotor in the conventional internal gear pump. Internal gear pump 1 of the present embodiment does not have a shaft provided in the inner rotor in the conventional one. In the shaftless structure, a bearing for rotatably supporting the shaft in housing 4 is not required.

### <Housing>

Housing 4 includes peripheral wall portion 40, first cover portion 41, and second cover portion 42, as shown in FIG. 1. Housing 4 rotatably houses inner rotor 2 and outer rotor 3. Peripheral wall portion 40, first cover portion 41, and second cover portion 42 form a pump chamber. In the present embodiment, peripheral wall portion 40, first cover portion 41, and second cover portion 42 are formed of members independent of each other.

Peripheral wall portion 40 is a tubular body surrounding the outer periphery of outer rotor 3. That is, peripheral wall portion 40 has a tubular shape. The lateral cross-sectional shape of the tubular is circular. An inner diameter of peripheral wall portion 40 is slightly larger than an outer diameter of outer rotor 3. Therefore, there is a slight clearance between the inner periphery surface of peripheral wall portion 40 and outer rotor 3. The clearance is appropriately selected within a range in which outer rotor 3 can rotate while being pressed by peripheral wall portion 40 and wear or seizure is hardly occur between peripheral wall portion 40 and outer rotor 3. A length of peripheral wall portion 40 along the axis is slightly longer than the length of outer rotor 3 along the rotary shaft. Peripheral wall portion 40 is made of, for example, an aluminum-based material. When peripheral wall portion 40 is made of an aluminum-based material, the weight of housing 4 can be reduced.

First cover portion 41 is a circular plate that covers the first end of peripheral wall portion 40. First cover portion 41 is disposed between stator 6 and outer rotor 3. First cover portion 41 does not have a hole penetrating through the front and back surfaces. First cover portion 41 includes an outer region and an inner region. The outer region is a region that is in contact with an end surface of peripheral wall portion 40. First cover portion 41 is fixed to peripheral wall portion 40, for example, by a bolt at an outer region. A part of the outer region of first cover portion 41 of the present embodiment is fixed to peripheral wall portion 63. First cover portion 41 may be an integral member with peripheral wall portion 40. First cover portion 41 may be an integral member with peripheral wall portion 63 of stator core 60. First cover portion 41, peripheral wall portion 40, and peripheral wall portion 63 may be an integral member.

The inner region includes a region disposed between stator 6 and outer rotor 3. A first clearance between first cover portion 41 and outer rotor 3 is, for example, 0.01 mm to 0.20 mm. When the first clearance is 0.01 mm or more, first cover portion 41 and outer rotor 3 are hardly slide on each other, and the occurrence of wear or seizure between first cover portion 41 and outer rotor 3 can be suppressed. The first clearance may be 0.03 mm or more, or 0.05 mm or more. When the first clearance is 0.20 mm or less, the fluid is hardly leak to the outer periphery of outer rotor 3 through the clearance, and the function of internal gear pump 1 is favorably exhibited. The first clearance may be 0.17 mm or less, or 0.15 mm or less. The first clearance may be 0.03 mm to 0.17 mm, or 0.05 mm to 0.15 mm.

The first clearance has a correlation with a second clearance between second cover portion 42 and outer rotor 3, which will be described later. Each of the first clearance and the second clearance varies depending on the position of outer rotor 3. Outer rotor 3 moves along the rotary shaft of outer rotor 3. For example, when outer rotor 3 is close to first cover portion 41, the first clearance is relatively small and the second clearance is relatively large. The value of the first clearance in the above range is a value in a state where second cover portion 42 and outer rotor 3 are in contact with each other, that is, a value in a case where the second clearance is zero. In other words, the sum of the first clearance and the second clearance is, for example, 0.01 mm to 0.20 mm.

First cover portion 41 is made of, for example, a nonmagnetic material. As described above, motor rotor 7 is rotated by the rotating magnetic field generated by coil 65 which is excited by a current passing through coil 65 in stator 6. The current flowing through coil 65 is, for example, an alternating current. When first cover portion 41 is made of a nonmagnetic material, the influence on the magnetic flux from stator 6 to motor rotor 7, that is, from stator 6 to outer rotor 3, is smaller than that in the case where first cover portion 41 is made of a magnetic material. When first cover portion 41 is made of a nonmagnetic material, outer rotor 3 is easily rotated appropriately by the rotating magnetic field of stator 6.

The nonmagnetic material is, for example, an aluminum-based material. When first cover portion 41 is made of an aluminum-based material, the weight of housing 4 can be reduced. The aluminum-based material is made of aluminum or an aluminum alloy. The aluminum is pure aluminum having a purity of 99 mass % or more. The aluminum alloy contains an additive element, and the balance is aluminum and inevitable impurities. First cover portion 41 made of an aluminum alloy is lightweight and has excellent wear resistance.

First cover portion 41 may be made of a phenol resin. First cover portion 41 made of phenol resin is light in weight.

A thickness of first cover portion 41 is, for example, 0.3 mm to 5 mm. When the thickness of first cover portion 41 is 0.3 mm or more, the strength of first cover portion 41 can be enhanced, and first cover portion 41 is hardly deformed even when outer rotor 3 slides on first cover portion 41. When first cover portion 41 is hardly deformed, the sealing performance of housing 4 can be enhanced. When the thickness of first cover portion 41 is 0.3 mm or more, the operation noise generated by inner rotor 2 and outer rotor 3 is hardly propagated to the outside of housing 4. The thickness of first cover portion 41 may be 0.5 mm or more, or 1 mm or more. When the thickness of first cover portion 41 is 5 mm or less, outer rotor 3 is easily rotated by the rotating magnetic field of stator 6. The thickness of first cover portion 41 may be 4 mm or less, or 3 mm or less. The thickness of first cover portion 41 may be 0.5 mm to 4 mm, or 1 mm to 3 mm.

Second cover portion 42 is a circular plate that covers the second end of peripheral wall portion 40. Second cover portion 42 includes an outer region and an inner region. The outer region is a region that is in contact with an end surface of peripheral wall portion 40. Second cover portion 42 is fixed to peripheral wall portion 40, for example, by a bolt at the outer region. Second cover portion 42 may be an integral member with peripheral wall portion 40. The inner region is a region facing inner rotor 2 and outer rotor 3. Second cover portion 42 may be made of a nonmagnetic material containing an aluminum-based material or a resin containing a phenol resin, as in the case of first cover portion 41. When second cover portion 42 is made of an aluminum-based material, the weight of housing 4 can be reduced. Second cover portion 42 made of an aluminum alloy is lightweight and has excellent wear resistance. First cover portion 41 and second cover portion 42 may be made of the same material or different materials.

Second cover portion 42 has a suction port 421 and a discharge port 422 that communicate with the inside of housing 4. Suction port 421 and discharge port 422 are flow paths. Suction port 421 and discharge port 422 are provided at positions facing each other across the center of outer rotor 3. Suction port 421 and discharge port 422 are provided so as to face the gap between inner rotor 2 and outer rotor 3. Suction port 421 and discharge port 422 of the present embodiment are both arc-shaped holes. Suction port 421 and discharge port 422 of the present embodiment extend along the rotary shaft of outer rotor 3 and are open at the end surface of second cover portion 42. Suction port 421 and discharge port 422 may be bent in L shapes, for example. In this case, suction port 421 and discharge port 422 are opened in a direction intersecting the rotary shaft of outer rotor 3. Suction port 421 and discharge port 422 can be opened in any direction according to the shapes of the pipes connected to internal gear pump 1.

Internal gear pump 1 of the present embodiment operates as follows. First, outer rotor 3 is rotated by the rotating magnetic field generated by coil 65 which is excited by passing a current through coil 65 in stator 6. When outer rotor 3 rotates, internal tooth 30 and external tooth 20 are engaged with each other, and thus inner rotor 2 rotates in the same direction by following outer rotor 3. An volume of the space formed by the respective tooth tips of internal tooth 30 and external tooth 20 increases and decreases by the rotation of outer rotor 3 and inner rotor 2. The fluid sucked from suction port 421 is discharged from discharge port 422 by the increase and decrease. The fluid is, for example, oil. The fluid may be water or a refrigerant.

### REFERENCE SIGNS LIST

1 internal gear pump
2 inner rotor
20 external tooth
3 outer rotor
30 internal tooth
4 housing
40 peripheral wall portion
41 first cover portion
42 second cover portion
421 suction port
422 discharge port
5 axial gap motor
6 stator
60 stator core
61 yoke
62 teeth
63 peripheral wall portion
65 coil
7 motor rotor
71 base portion
72 magnet
9 pin

1. An internal gear pump comprising:
an inner rotor including a plurality of external teeth;
an outer rotor including a plurality of internal teeth engaging with the plurality of external teeth;
a housing rotatably housing the inner rotor and the outer rotor, and
an axial gap motor including a stator and a motor rotor,
wherein the outer rotor is the motor rotor,
wherein the housing includes
a peripheral wall portion provided in a cylindrical form so as to surround an outer periphery of the outer rotor, and
a first cover portion and a second cover portion each covering a corresponding one of two end portions of the peripheral wall portion,
wherein the first cover portion is disposed between the stator and the outer rotor, and
wherein the second cover portion has a suction port and a discharge port that communicate with an inside of the housing.

2. The internal gear pump according to claim 1,
wherein the first cover portion is made of a nonmagnetic material.

3. The internal gear pump according to claim 1,
wherein a thickness of the first cover portion is 0.3 mm to 5 mm.

4. The internal gear pump according to claim 1,
wherein a clearance between the first cover portion and the outer rotor is 0.01 mm to 0.20 mm.
